(19) United States
(12) Patent Application Publication
(10) Pub. No.: US 2023/0093690 A1
(43) Pub. Date: Mar. 23, 2023

(54) Fan Valuation Method, System, and Uses Thereof

(71) Applicant: Pumpjack Dataworks, Inc., Fort Worth, TX (US)

(72) Inventors: Nicholas Goggans, Fort Worth, TX (US); Thomas Tercek, Boulder, CO (US); Wyatt Gallagher, Las Vegas, NV (US); David Cedrone, Austin, TX (US)

(21) Appl. No.: 17/952,128

(22) Filed: Sep. 23, 2022

Related U.S. Application Data
(60) Provisional application No. 63/247,440, filed on Sep. 23, 2021.

(51) Int. Cl. G06Q 30/02

(52) U.S. Cl. CPC G06Q 30/0201

(57) ABSTRACT

A system and method determines the monetary value of a sports fan. Fan data is ingested from a plurality of data sources. The data sources comprise first party data, second party data, and third party data. The data is processed and stored in a fan database. The fan data comprises values for a plurality of fan traits. The fan trait values are mapped to points which are then converted to a monetary value according to various rules which may be set by sports clients or advertisers. The aggregate monetary value for a fan is of great value to teams, sports organization, sports clubs, sports league, sports federations, and advertisers. The profile values and fan data is useful for creating incentive campaigns and for selling and exchanging fan data in a marketplace.

This application claims the benefit of U.S. Provisional Application No. 63/247,440, filed Sep. 23, 2021, which is hereby incorporated by reference.

### BACKGROUND

Sports fans throughout the world represent one of largest most lucrative groups of interest to marketers. While there is abundant market research that attempts to analyze and report on the various demographics, general spending power, and general behaviors of sports fans, these reports act only as a general advisory tool to marketers and others that may be interested in promoting products and services to sports fans.

Teams, clubs, sports organizations, and advertisers have no way to reliably and consistently visualize and quantify the value of their sports fans. They have no way to identify and quantify the location and engagement habits of fans. They have no way to collect disparate and inconsistent types of fan data. They have no way to understand what content is working best on web and mobile devices to engage fans and increase sales. They have no way to understand every level of participation, team engagement, and purchase.

Therefore, a need presently exists for systems and methods that can collect the identity, location, and engagement habits of every fan. A need presently exits for a system and method to access that data and provide insights into fans and groups of fans. A need presently exists for a system and method to determine the monetary value of a fan. A need presently exists to be able to filter for groups of fans meeting any number of criteria and determine the monetary value of that group. A need presently exists for a system and method where the sports fan in control of his or her data. And a need presently exists for sports fan data exchange for trading fan data between organizations and creating targeted advertising campaigns to sports fans.

### SUMMARY

A method for determining the monetary value of a sports fan comprises a plurality of steps as follows. A plurality of fan traits is provided. First party data, second party data, and third party data is ingested from a plurality of data sources operable to provide demographic, transactional, and membership data of sports fans. Th ingested data is processed to extract fan trait values for a plurality of fans. The fan trait values are stored with the fan traits for each of the plurality of fans in a fan database. A trait value category is defined having a minimum category monetary value and a maximum category monetary value. A plurality of trait value properties are defined. The trait value properties are associated with the trait value category. The trait value properties comprise rules that map fan trait values in a fan database to points.

For a fan, a point value for the plurality of trait value properties is computed according to the rules. For the fan, a monetary value for the trait value category is computed by converting the point value to a monetary value in the range of the minimum category monetary value and the maximum category monetary value.

The steps are repeated to determine additional trait value category monetary values for the fan. The fan profile value is determined by adding all of the trait value category monetary values.

Web browser executable code accessible over the internet is generated. The cod, when accessed by a remote computer of a sports client or advertiser causes the display of the remote computer to display a fan profile page including the fan profile value, demographic date, and fan activity information.

### BRIEF DESCRIPTION OF THE DRAWINGS

FIG. 1 shows a fan valuation system FIG. 2 shows an exemplary sources page displayed to a client.

FIG. 3 shows an exemplary trait value category configuration webpage.

FIG. 4 shows an exemplary trait value properties configuration webpage.

FIG. 5 shows a first exemplary fan profile with demographics, data permission, and profile value information.

FIG. 6 shows a second exemplary fan profile page showing fan activity.

FIG. 7 shows an audiences overview webpage including golden records and values for fans.

FIG. 8 shows a total fan value page, including a graph showing total fan value by day.

FIG. 9 shows an exemplary goals page.

FIG. 10 illustrates funnel captured per each campaign FIGS. 11A-D shows configuration screens of an exemplary financial incentive campaign for a company that would like to advertise to a group of sports fans having particular traits.

FIGS. 12A-E shows exemplary screens of a fan app for a fan targeted by the activated campaign shown in FIGS. 11A-C.

FIGS. 13A-C shows configuration screens of an exemplary offer to exchange data between clients.

FIG. 14 shows the architecture of an exemplary mobile communication device.

FIG. 15 is a method for determining a monetary value of a sports fan.

### DETAILED DESCRIPTION

“Fan Data” is data associated with a sports fan and that can be used to uniquely identify that that fan. Each piece of data is a “trait” of a particular fan. A sports fan is thus defined by a plurality of traits, or variables, the values of which are unique and representative of attributes about each fan. Each trait is represented by a digital data having a particular data type. Data types include numeric range, text, Boolean, number, and percentage.

A category comprises a plurality of traits. There are a plurality of categories. Three exemplary categories are Demographics, Transactions, and Membership.

For example, the Demographics category includes the following traits. The data type of each trait is shown in parenthesis: Age (numeric range), Gender (text), Has Geocoded Address (Boolean), Home Owner (Boolean), Home Value (numeric range), Commute Miles to Stadium (numeric range), Education (text), Occupation (text), Married (Boolean), Children (Boolean), Grandchildren (Boolean). Other demographic traits include first name (text), last name (text), email (text), phone (text), address (text), city (text), state (text), zip code (text), country (text), date of birth (text), age (text), nationality (text), preferred language (text).

The Transactions category includes the following traits: Days Since Last Transaction (numeric range), Total Number of Transactions (numeric range), Total Dollars Spent (Numeric Range), Number of Sources (Numeric Range), Percentage of Automated Sources (Percentage).

The Membership category includes the following traits: Club Member (Boolean), Single Game Ticket Buyer (Boolean), Ticket Package (Multi-game) Buyer (Boolean), Season Ticket Holder (Boolean), Days Since Last Read Article (Numeric Range), Days Since Last Entered Contest (Numeric Range), Days Since Last Video Watch (Numeric Range), Days Since Last Campaign Engagement (Numeric Range), Days Since Last App/Site Login (Numeric Range), Website User (Boolean), Mobile App User (Boolean), Push Notifications Enabled (Boolean), Can Email User and Have Email Address (Boolean), Can SMS/Text User and Have Phone Number (Boolean), Can Send Physical Mail and Have Address (Boolean), Twitter Follower (Boolean), Twitter Token (Boolean), Instagram Follower (Boolean), Facebook Follower (Boolean), Facebook Token (Boolean), Paid Content Subscriber (Boolean), Loyalty Program Member (Boolean), Is Gambler (Boolean), Is New Member (0-90 days) (Boolean).

These lists of traits and categories are illustrative of just some of the data that may be associated with a fan. In some cases, for each fan, some traits may be known and some traits may be unknown.

A Fan Database comprises the fan data. Trait values may change over time as fan demographics, transactions, and membership changes. These changes, along with timestamps for each trait, are stored the fan database as well.

Fan data is received from a variety of sources, alone and in combination. There are three categories of data sources: first-party data, second-party data, and third-party data.

First-party data is fan data collected directly by a team, sports organization, sports club, sports league, or sports federation. This first-party data is collected about fans who directly interact with the organization by way of websites, apps, ticket purchases, merchandise purchases, point-of-sale communications, kiosks, web and mobile SDKs, APIs, and other means. For example, team merchandise purchased through a team's website collects first-party data.

An exemplary app that can collect first-party data is the Real Madrid App (https.//wwwrealmadrid.com/landings/RealMadridApp/index.en_html). Another example app is the Club Tijuana website and associated (https.//xolos.com.mx/) Yet another example is the Inter Miami CF app (https.//www.intermiamicf.com/club/app).

These apps and websites provide fans with and allows fans to interact with news, videos, club information, player stats, and tournament information. The apps, among other things, provides direct access to a store, video footage, team and play stats, news stories, official videos, and the ability to purchase tickets.

With respect to purchasing tickets, in one embodiment the app is modified so that ticket purchases are stored on a blockchain. For example, a ticket may be sold as an NFT (non-fungible token). This is useful because tickets are often resold on secondary markets. By tokenizing tickets, all resales of tickets can be tracked, verified, and a portion of each resale price can be sent to the original ticket seller or issuer, for example a team.

Many teams, organizations, and clubs have similar apps. Some apps allow the purchase of tickets and merchandise such as club and team branded clothing directly through the app. The app provides geolocation information of the fan. Many apps supply team and sports news, video, as well as player information and stats. The app can collect first-party on how a fan consumes and interacts with news, video, and player information.

In another example, the Association of Tennis Professionals (ATP) has an ATP Tour App and Live Streaming App. The ATP Tour App provides fans with live scores, stats, customized news and video feeds of players and tournaments, and fresh content alerts. The Live Streaming App provides live streaming videos of ATP events.

These apps also collect fan information upon registration, such as names, addresses, emails, phone numbers, and other data about the fan.

One example of a website that collects first-party data is the ATP Tour Shop (https.//www.tennis-point.com/atp-shop/a/atp_shop). Another example is the Dallas Mavericks online merchandise shop (https.//dallasmays.shop/). The first-party data available from websites such as these include, at least, purchases that fans make, how much they spend, and names, addresses, phone numbers, emails, and other fan identifying and behavioral information.

First-party data may be collected from websites that offer sweepstakes or competitions. One example is from Williams Racing (https.//www.williamsfl.com/win). Williams Racing also has an online store (http.//storewilliamsfl.com/) where they sell merchandise, thereby collecting additional first-party data.

Data collected by an organization through a CRM system (customer relationship management system) such as Salesforce CRM is also first-party data.

Data may additionally be collected at events, for example by wifi when a fan connects to the wireless network at a stadium with a mobile phone, via sensors at the stadium such as RFID, via QR codes scanned by with a mobile communication device of fan, and via POS systems when a fan makes a purchase at the venue.

All of the data collected by these apps, websites, and other means disclosed above, which includes at least demographic data, purchases, geolocation data, and in what way and for how long a fan interacts with the app and other fans via the app are stored as attributes connected with each fan in the fan database.

Second-party data is someone else's first party data. It is data that belongs to another company. For example, teams and clubs may have a presence on social media. Social media companies such as Facebook, Instagram, and YouTube collect data on users, that is fans, as they interact with team and club pages. This second-party data is available, and may be for sale, to the teams and clubs and can by agreement be made available for ingestion into the fan database of the present invention.

One example of a club social media page that collects second-party data is the Club Tijuana Facebook page (https://www.facebook.com/xoloitzcuintles/). Another example is the Club Tijuana Instagram profile @xolos (accessible via the Instagram app or via https.//www.instagram.com/xolos). Yet another example Club Tijuana Xolos YouTube page (https://www.youtube.com/user/XoloTV).

All user data and analytics collected by Facebook, Instagram, YouTube, or any other social media company can be ingested into the fan database of the present invention as second-party data. That fan data and associated attributes or traits add to the profile connected to and built upon for each fan in the fan database.

Other types of second party data include ticket sales data for example sales from Ticketmaster (https.//ticketmaster.com/), merchandise point of sale data, merchandise sales data from websites that sell sports merchandise like team jerseys for example from Fanatics (https.//www.fanatics.com/), and so forth.

Third-party data is data aggregated from various sources. This data is generally obtained from various other platforms and websites where it was generated. Third-party data providers collect this data, aggregate it into large data sets, and sell it as third-party data. Third-party data may provide additional or confirming information on fans such as regional demographics, age, gender, location, and the like.

By way of example, third-party data is available from consumer research companies such as YouGov (https.//business.yougov.com/) Nielsen (https.//www/nielsen.com/), GWI (https.//www.gwi.com/), and Acxiom (https.//www.acxiom.com/).

Third-party data is also ingested by the present invention. The data is matched up with each fan and stored as attributes to further build and develop a more complete fan profile. The third-party may additionally be used to confirm the accuracy of ingested first-party and second-party data.

First-party, second-party, and third-party data may be ingested in a variety of means and method, including but not limited to: an SDK and/or API embeddable into or addressable with websites, mobile device such as iPhones and Android phones, and IoT devices; SFTP transfer pipelines from the holder of the data to the present invention for the transfer of CSV, JSON, AVRO, and XML files; direct database access to pull data from client databases to the present invention; Apache Kafka streaming; Amazon Kinesis streaming; scrapers such as Python or Selenium-based screen scrapers that pull data out of an online system. In one embodiment, the present invention is implemented on Amazon Web Services Cloud (AWS Cloud), thereby providing scalable and redundant storage and processing for the large amount data that is ingested on a continual basis by the present invention.

Various methods known by those having ordinary skill in the art may be used to process the ingested data and load it into the fan database. By way of example, generally the processes of ETL, or Extract, Transform, and Load, include various methods operable to combine data from multiple data sources into a single, consistent data store that is loaded into a database. During extraction, raw data imported from source locations into a staging area, such as a data lake. In the staging area, the raw data undergoes processing. The data is transformed and consolidated. Some examples of transforming and consolidating include, filtering, cleansing, de-duplicating, validating, and authenticating the data. Other examples include removing, encrypting, or protecting data governed by industry or governmental regulations. Still other example formatting the data into tables or joined tables to match the schema of the fan database. During the Load step, the transformed data is moved from the staging area into the target database, that is, the fan database.

In this way, the fan database comprises a plurality of data attributes or traits on a plurality of fans. A fan profile is generated comprising attributes associated with that fan, as obtained from the first-party, second-party, and third-party data.

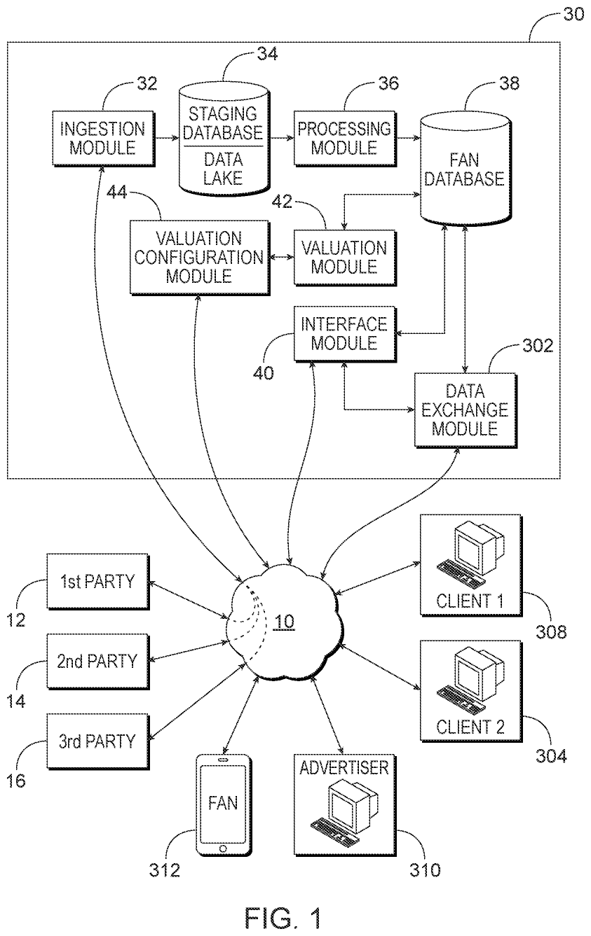

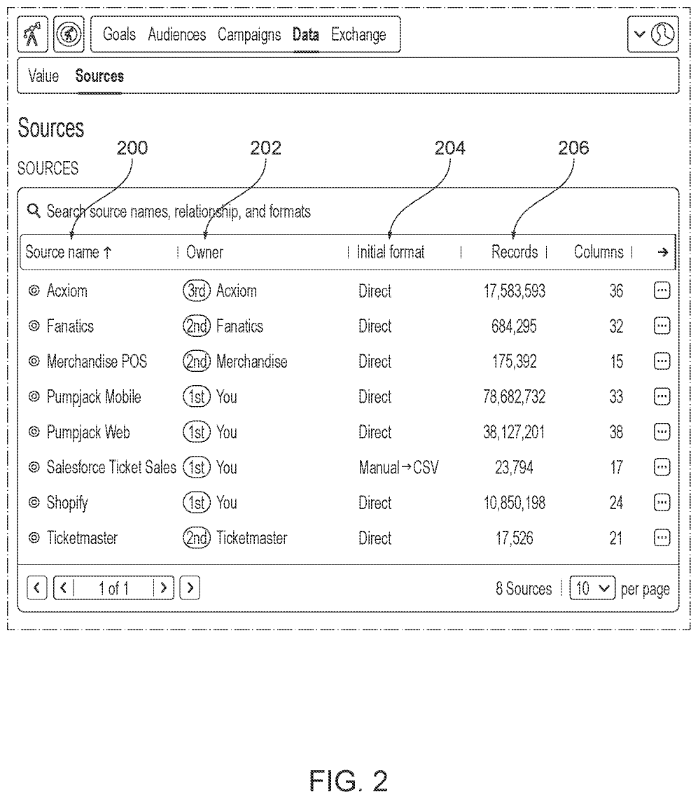

FIG. 1 shows a fan valuation system. First party data sources 12, second party data sources 14, and third party data sources 16 are in communication with network 10. Network 10 is a network such as the internet.

The fan valuation system 30 comprises an ingestion module 32 in communication with the network 10 for ingesting fan data from the plurality of sources 12, 14, 16, as disclosed above. The ingestion module 32 is in communication with a staging database or data lake 34 for storing the data as-is in original formats for data lineage. The data lake 34 is in communication with a processing module 34 for extracting, transforming, and loading fan data in to the fan database 38. The fan database 38 is in communication with the processing module 36.

Clients 308 and 309 are in communication with network 300. Two clients are shown but there may be additional clients in communication with the network. An advertiser 310 is in communication with network 300. One advertiser is shown, but there may be a plurality of advertisers in communication with the network 300. A fan mobile communication device 312, such as a mobile phone, is in communication with network 10. Only one mobile device 312 is shown for illustrative purposes but there may be many mobile phones in communication with network 10.

Exemplary clients include teams, clubs, federations, and sports organizations. An advertiser 310 can be any company or organization that wants to advertise a their products or services to a group of fans 312 of a client 308, 309.

An interface module 40 is in communication with network 10 and fan database 38 for receiving requests and queries from clients 308, 309, advertiser 310, and fan 312, querying and obtaining data from the fan database 38, and communicating the data to one or more of the clients 308, 309, advertiser 310, and fan 312. Exemplary clients include teams, clubs, and sports organizations as was disclosed above. An advertiser 310 can be any company that wants to advertise their products or services to a group of fans 312 of the client 308.

The interface module 40 is operable to generate and serve interactive web pages, communicate data by way of an API, push email and SMS/text messages, and otherwise communicate data by other well known means for communicating and displaying information from one computing system to another.

FIG. 2 shows one exemplary screenshot of a webpage displayed on a client computer which shows the sources 12, 14, 16 in the system for any client 308, 310. In this way a client can see what sources 200 they have connected with and how many records 206 are associated with each source. Also shown is who owns the data 202, that is the name of the owner and whether it is first, second, or third party data. Also shown is how the data was obtained 204, for example directly or by manual import.

Valuation

Turning back to FIG. 1, a valuation module 42 is in communication with the fan database 38. The valuation module determines a monetary value for a fan or fans whose profile is stored in the fan database. This fan value, also referred to herein as a profile value, is a function of the traits described above and associated with the fan. The value of each trait is compared to a set of rules and points values are determined based on which rules matches the traits. The points are then mapped to a monetary value for a particular category. This will be disclosed in greater detail below.

A valuation configuration module 44 is in communication with the valuation module and the network. Clients 308, 309 or advertisers 310 can configure, via a web interface, the rules, categories, and traits that are used in computing the fan profile value.

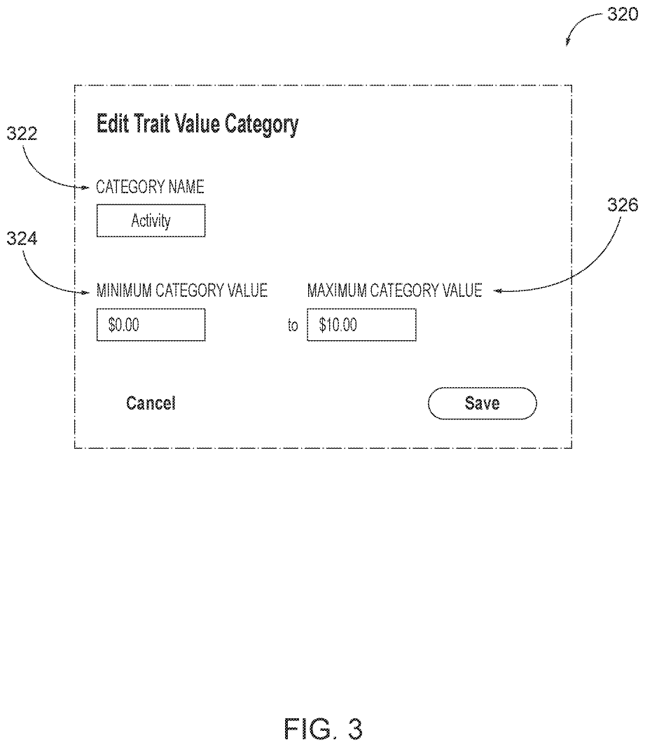

A Trait Value Category (TVC) is configured to have a minimum dollar category value (a) and a maximum dollar category value (b). For example, FIG. 3 shows a web configuration page 320 displayed to a client by way of the Valuation Configuration Module (44 of FIG. 1) to configure a Trait Value Category. In this example, Category Name 322 is Activity, the Minimum Category Value 324 is $0.00 (b=0) and the Maximum Category Value 326 is $10.00 (a=10). This is just one example of a Trait Value Category. There may be a plurality of user defined Trait Value Categories having many different names and wide-ranging minimum and maximum monetary values. In one embodiment the system comprises a plurality of default Trait Value Categories with default minimum and maximum category values. The users can modify these defaults by way of a web interface through Valuation Configuration Module 44.

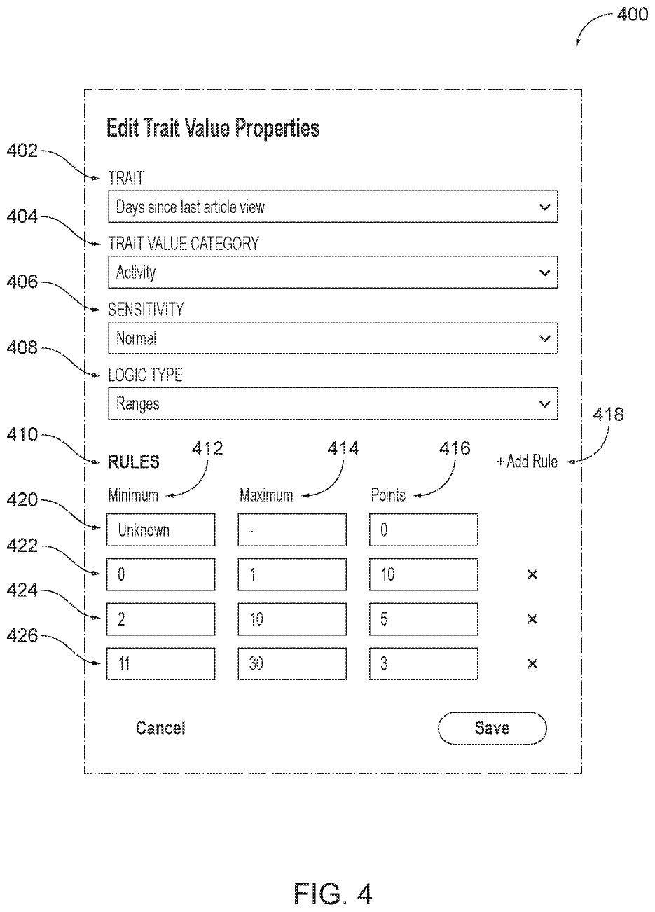

Trait Value Properties (TVP) define a set of rules to evaluate the traits disclosed above with reference to Fan Database (38 of FIG. 1). FIG. 4 shows an exemplary Trait Value Properties configuration webpage 400. This webpage is displayed to a client by way of the Valuation Configuration Module (44 of FIG. 1) to configure the Trait Value Properties. Briefly, The value of fan trait which is received from the Fan Database is evaluated against one or a set of Rules 410 to determine a Point value (X) 416 for that Fan Trait 402.

The TVP comprises the name of the Trait to evaluate 402, the TVC the TRP belongs to 404, a logic type such as Boolean, Ranges, or Match 408, and the Rules 410 to assign a point value to the TVP according to value of the Trait. The TVP may also optionally comprise a Sensitivity setting 406. Recall, the value of the Trait for a fan is received from the Fan Database.

In the example of FIG. 4, the Trait 402 is “Days since last article view”. The TVC 402 is “Activity”. The Logic Type 408 is “Ranges”. There are a plurality of Rules 410. Rules can be added 418 or deleted. The Trait value for the fan is evaluated against the Rules 410 to determine a Point (X) value 416. Examples will follow to further clarify this.

In the example of FIG. 4, the rules comprise a plurality of ranges 420-426. A permanent default rule 410 exists if the Trait value (that is the value of fan train received from the Fan Database, referred to herein as a variable TC) being evaluated is unknown. The points 416 for Unknown is 0. Thus, if TC=unknown for “Days since last article view” for a fan in the fan database 420, then the this trait value is X=0 points 416. In 422, if TC is a minimum of 0 days and maximum of 1 days then the trait value X=10 points. If TC is between 2 and 10 days 224, then X=5 points 416. And if TC is from 11 to 30 days 426, then X=3 points 416.

So, in one example for the Trait Value Property 400, assume the Trait Value Category for Activity 404 has a minimum monetary value a=$0 and a maximum monetary value b=$3. Also, for illustrative purposes and for simplicity of this example, assume as that there is only one Trait Value Property 402 in the TVC configured in as shown in FIG. 3, that is TVC={TVP₁}, meaning that the Trait Value Category contains only a single Trait Value Property member in its set. The minimum number of points possible Xₘᵢₙ=0 (the intersection of 420, 416) and the maximum number of points possible Xₘₐₓ=10 (the intersection of 422, 416). The minimum monetary value for the TVC is a=0 and the maximum monetary value is b=10.

The Fan Value X′ of any Trait Value Category for a Fan Trait Point Value X is:

$${X}^{′} = a + \frac{( X - {X}_{min} ) ( b - a )}{{X}_{max} - {X}_{min}}$$

So for example if the Fan Trait value TC obtained from the Fan Database is 14 days since last article view, then values is compared to the rules 410 and the number of Fan Trait points X=3. In this case the Fan Value of this Trait Value Category is X′=3, that is $3.00.

In a more complex example, and with the above understanding in mind, a Trait Value Category (TVC) typically consists of a plurality of Trait Value Properties (TVP), that is, TVC consists of a set of TVPs:

TVC={TVP₁,TVP₂. . . TVPₙ}

So, most generally, a TVC comprises the following:

| Trait Value Property | Minimum Points | Maximum Points |
|---|---|---|
| TVP₁ | X_{1 min} | X_{1 max} |
| TVP₂ | X_{2 min} | X_{2 max} |
| . . . | . . . | . . . |
| TVPₙ | X_{n min} | X_{n max} |

And so, in view of the above table and the Fan Value equation above to compute X′:

Xₘᵢₙ=sum of minimum point values of all possible traits in the Trait Value Category (TVC)=Σᵢ₌₀ⁿ X_{1 min}

Xₘₐₓ=sum of maximum point values of all possible traits in the Trait Value Category (TVC)=Σᵢ₌₀ⁿX_{1 max}

So, in one example, to compute a profile value for a fan, the fan trait values TC are obtained from the Fan Database, the Fan Value X′ for each Trait Value Category are computed, and all Fan Values X′ for all Trait Value Categories are added together to arrive at a monetary value that the fan is worth.

A more complex example of a TVC computation will now be shown for illustrative purposes. In this example, the TVC is Demographics: Let a=0, that is the minimum monetary value=$0

Let b=5, that is the maximum monetary value=$5.00

In this example, the Trait Value Properties and rules for TVP₁ “Age” are:

| Range | Points |
|---|---|
| Unknown | −1 |
| 0-13 | 0 |
| 14-17 | 0.5 |
| 18-20 | 0.5 |
| 21-24 | 1 |
| 25-29 | 1 |
| 30-34 | 1.3 |
| 35-39 | 1.6 |
| 40-44 | 1.9 |
| 45-49 | 2.2 |
| 50-54 | 1.9 |
| 55-59 | 1.6 |
| 60-64 | 1.3 |
| 65-69 | 1 |
| 70-74 | 0.7 |
| 75-200 | 0.4 |

As can be seen for Age, X_{1 min}=˜1 and X_{1 max=}2.2

And the Trait Value Properties and rules for TVP₂ “Has Geocoded Address” are:

| Boolean | Points |
|---|---|
| Unknown | −1 |
| Yes | 2.2 |
| No | 0 |

As can be seen, X_{2 min}=˜1 and X_{2 max}=2.2

And the Trait Value Properties and rules for TVP₃ “Occupation” are:

| Text | Points |
|---|---|
| Unknown | 0 |
| Unemployed | −1 |
| Student | 0.25 |
| Blue Collar | 0.5 |
| White Collar | 0.75 |
| Business | 1 |
| Owner/Executive | |
| Retired | 0.5 |

As can be seen, X_{3 min}=—1 and X_{3 max}=0.75

So,
Xₘᵢₙ=X_{1 min}+X_{2 min}+X_{3 min}=−3
Xₘₐₓ=X_{1 max}+X_{2 max}+X_{3 max}=5.15

In this example the fan is 42 years old, does not have a geolocated address, and is blue collar. Referring to the rules above, X₁=1.9 points, X₂=—1 points, X₃=0.5 points. So,
total fan points=X=X₁+X₂+X₃=1.4

And,
Fan Value=X′=2.70, that is $2.70.

With these methods, utilizing the above disclosed system and methods, a monetary profile value for every fan in the Fan Database 38 can be determined according to default and/or user-defined or user-modified categories, properties, and rules.

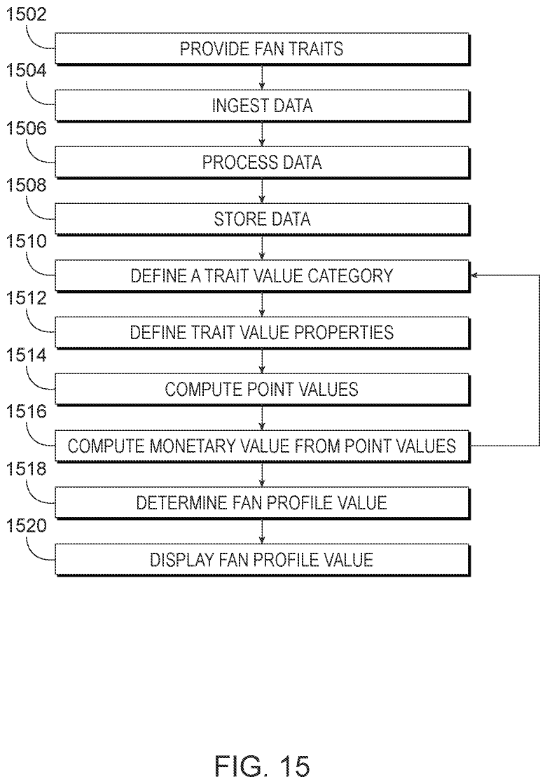

In view of the above disclosure, FIG. 15 is a method for determining a monetary value of a sports fan. A plurality of fan traits is provided at step 1502. At 1504 first party data, second party data, and third party data is ingested from a plurality of data sources operable to provide demographic, transactional, and membership data of sports fans.

At step 1506 the ingested data is processed to extract fan trait values for a plurality of fans. At step 158 the fan trait values with fan traits for of the plurality of fans are stored in a fan database.

At step 1510, a trait value category is defined having a minimum category monetary value and a maximum category monetary value. At step 1512 a plurality of trait value properties are defined, the trait value properties associated with the trait value category. The trait value properties comprise rules that map fan trait values in the fan database to points.

At step 1514, for a fan, a point value is computed for the plurality of trait value properties according to the rules. At step 1516, for the fane, a monetary value of trait value category is computed by converting the point value to a monetary value in the range of the minimum category monetary value and the maximum category monetary value. Step 1516 loops back to step 1510 to determine additional trait value category monetary values for the fan.

At step 1518 the fan profile value is determined by adding all of the trait value monetary values computed in step 1518.

Finally, web browser executable code accessible over the internet that when accessed by a remote computer of a sports client or advertiser a causes the display of the remote computer to display a fan profile page including the fan profile value, demographic data, and fan activity information.

Turning back to FIG. 1, the fan database 38 can be queried in any number of ways by way of the interface module 40 that may be useful to marketers which may include clients 308, 309, and advertiser 310. For example, the fan database can provide insights into fans, fan behavior, product engagements, sales, and like by constructing SQL queries and creating visualization of the results of those queries. The visualizations are served as internet accessible webpages by way of interface module 40 and are useful to data rights holders, teams and other organizations, marketers, and advertisers.

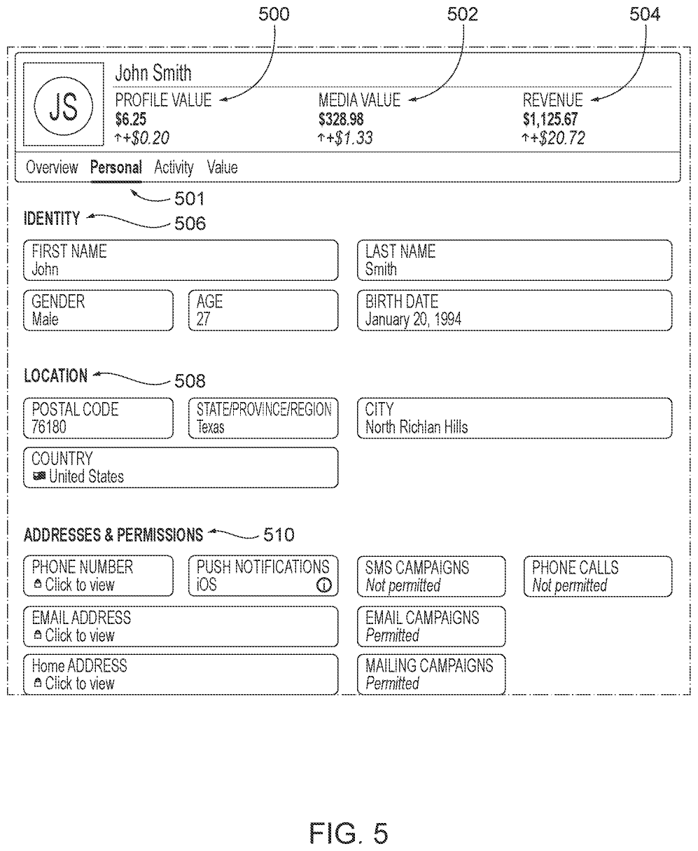

FIG. 5 shows a first exemplary fan profile with Personal information 501 such as demographics, data permission, and profile value information. Fan valuation is displayed at the top of the page. Profile Value 500 is the fan value, determined as disclosed above. In this example the fan value is $6.25, which is up $0.20 from the previous calculation based on the previous set of fan data Media Value 502 is the product of a fan's engagement, demographics, and purchasing power. Media value is a function of how much data a fan shares and how much money the fan spends. The more of each, the higher the media value. Revenue 504 is the total revenue the fan generated through purchases of tickets, merchandise, memberships, subscriptions, and so forth.

Also displayed is Identity information 506 such as name, gender and age. Location information 508 such as postal code, State, City, and Country. And also displayed are Addresses and Permissions 510 indicating what data is available, permitted, and viewable according to permissions and preferences set by the fan. Examples include Phone Number, Email Address, Home Address, Push Notifications, SMS Campaigns, Email Campaigns, Mailing Campaigns, and Phone Calls.

As shown with reference to the valuation, each fan has control over what information, such as contact information, may be shared. Fan data includes permissions. In one embodiment the data is controlled and regulated according to regulations such as GDPR or CCPA, or others, alone and in combination.

As can now be understood from the disclosure above on valuation, the more information a fan makes available or permissible, the higher the profile value.

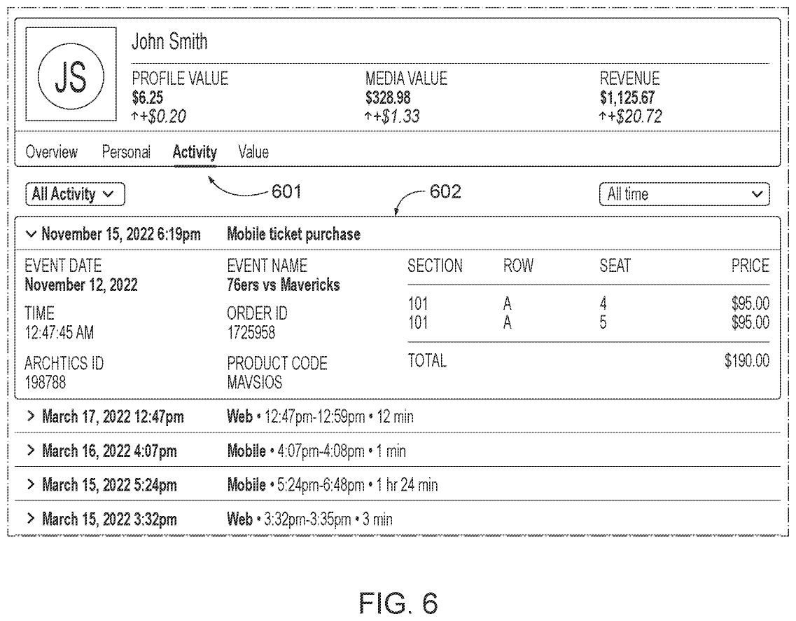

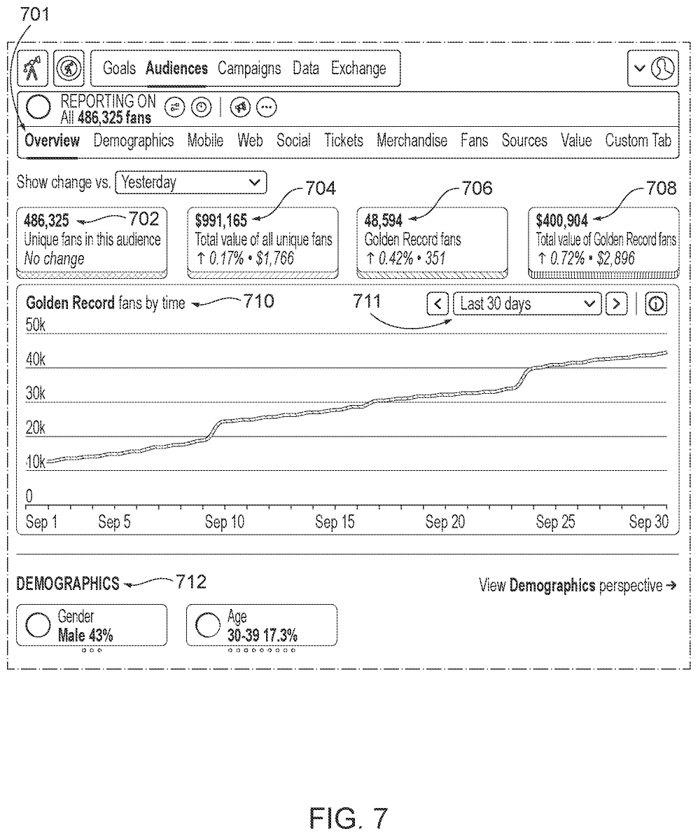

FIG. 6 shows a second exemplary fan profile page showing fan activity 601. This page displays a fan's digital history including purchases, web access, mobile access and so forth. Every session and screen is captured and timestamped, thereby providing an accurate portrayal of a fan's activity, and providing fan data that may be useful for computing fan profile scores.

FIG. 7 shows an audiences overview webpage. The Overview screen 701 displays a clients Golden Record. The Golden record is a record of known fans, having name, email, and zip code in the system, who have granted the team permission to contact them. Displayed here are the Unique fans in this audience 702, the Total value of all unique fans 704, in this example $991,165. The number of Golden record fans 706 and the Total value of Golden Record fans 708, which in this example is $400,904. A graph of Golden Record fans by time 710 is shown and the period of the graph can be selected by the user 711. Demographics information 712 is also displayed.

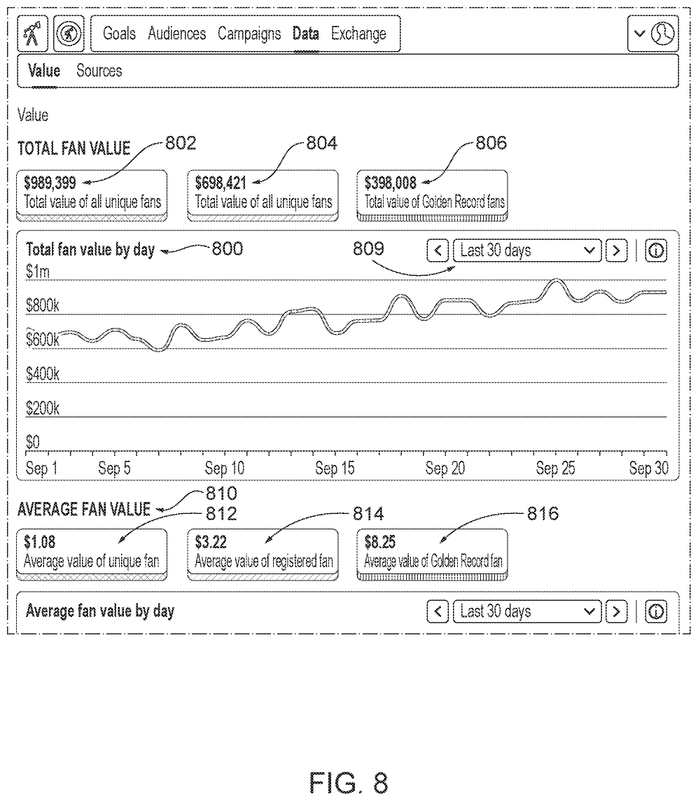

FIG. 8 shows a total fan value page, including a graph showing total fan value by day. The total value of all unique fans 802 is $989,399. The Total value of registered fans 804 is $698,421. The total value of Golden Record fans 806 is $398,008. A graph of the Total fan value by day 808 is shown. The user can select the time period of the graph 809. On the bottom, Average Fan Value 810 is shown. The Average value of unique fan 812 is $1.08. The Average value of registered fan 814 is $3.22. The Average value of Golden Record fan 816 is $8.25. Other graphs and information may be shown, such as Average fan value by day.

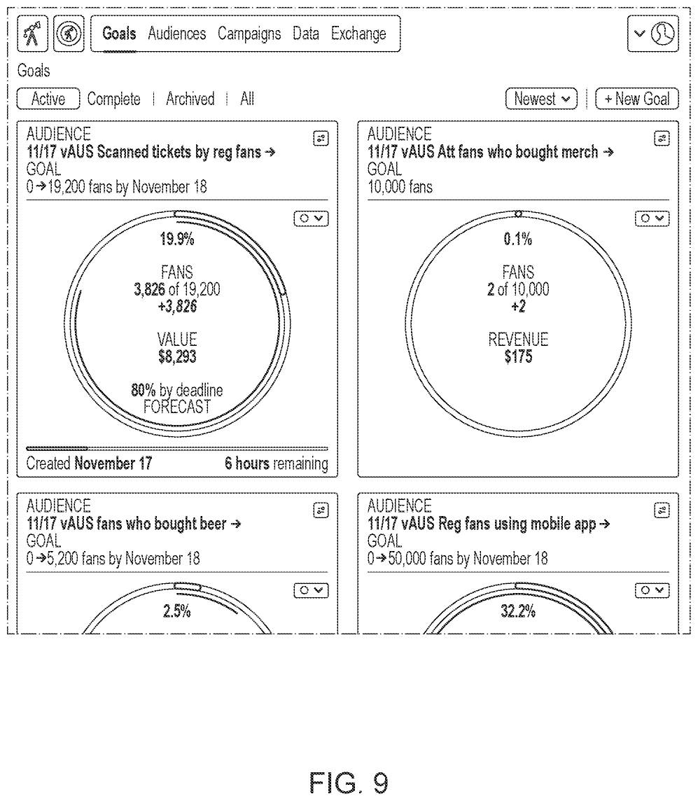

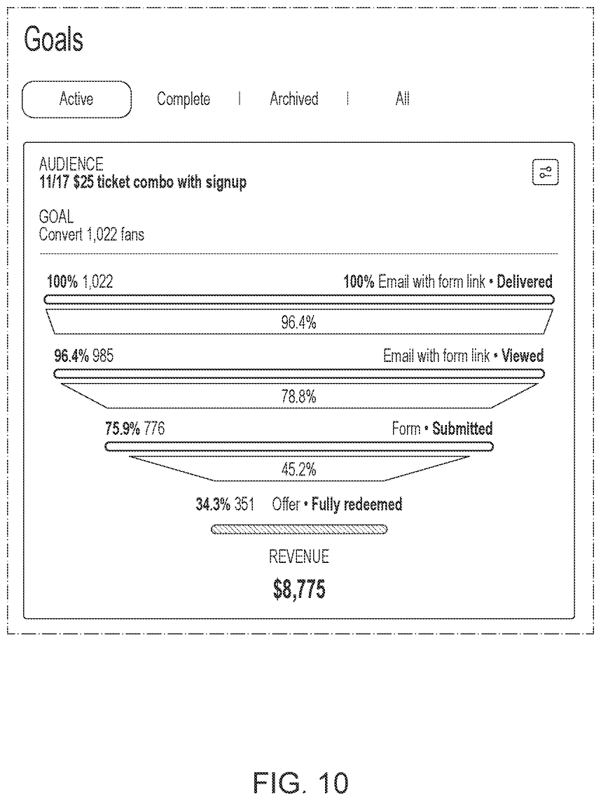

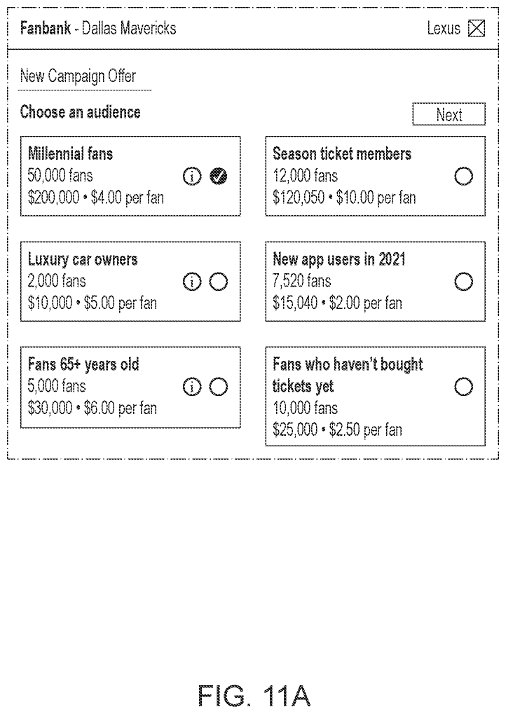

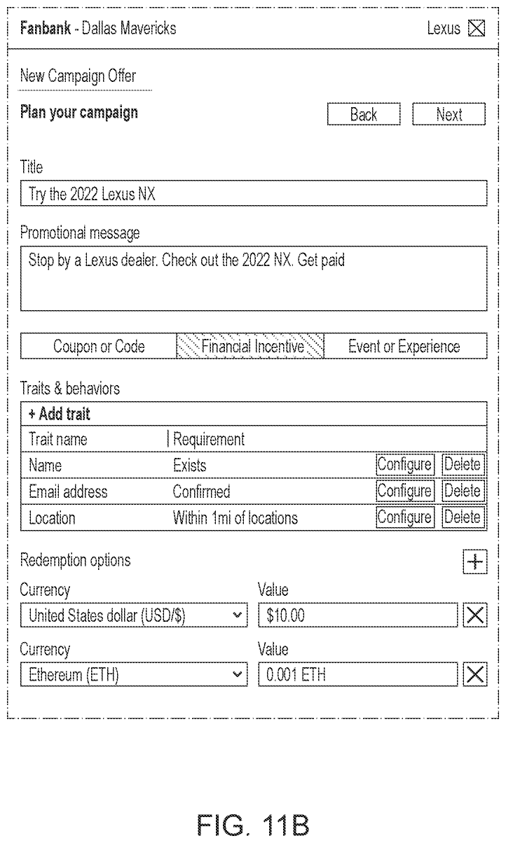

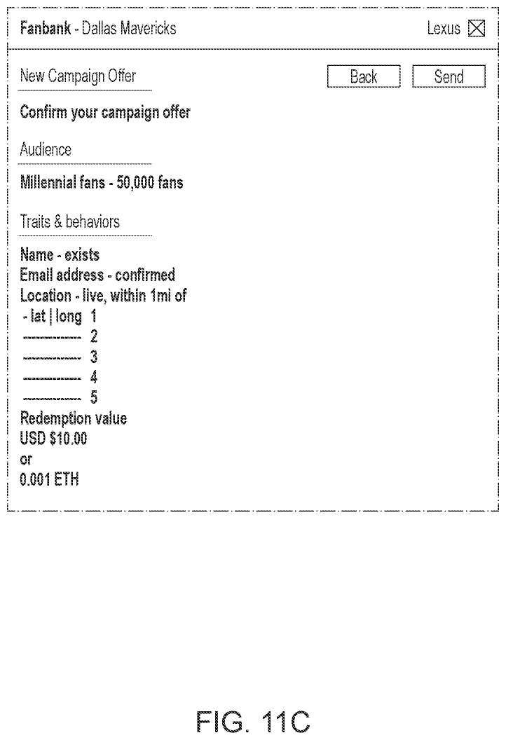

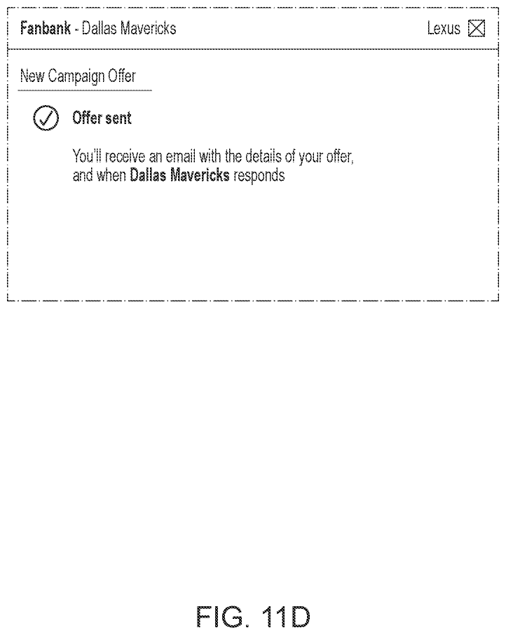

FIG. 9 shows an exemplary goals page. Examples of goals include number of tickets sold for a particular game, and campaign reach for a particular sponsor partner. FIG. 10 illustrates funnel captured per each campaign

Turning back to FIG. 1, the system 30 may optionally include a data exchange module 301. The data exchange module is in communication with the fan database 38 and the interface module 40.

The data exchange module 302 enables the exchange of fan data and the ability to target and advertise to groups of fans according to certain criteria of interest to the advertiser. Filters, which query the fan database 304, to identify groups of fans according to various criteria were disclosed above.

In one embodiment, advertiser 302 would like to create an incentive campaign for fans of client 1. The fan or groups of fans is represent by fan mobile device 312. While only one mobile fan mobile device 312 is shown in FIG. 1, there are a plurality of fan mobile devices in communication with network 300. In one example, there are millions of fan mobile devices.

With this in mind, FIGS. 11A-D shows configuration screens of an exemplary financial incentive campaign for a company that would like to advertise to a group of sports fans having particular traits. The campaign is configured at data exchange module 302 by client 308 and advertiser 310 via a web browser configuration interface. FIGS. 11A-D show exemplary pages of the web browser interface.

FIG. 11A shows an audience configuration screen for an exemplary campaign that the car company Lexus would like to target certain Dallas Mavericks fans. In this example, Lexus may select any one or more than one category of fans to target. In this example, there are six groups of fans having certain attributes and monetary value per group. The fans that comprise the members of the groups are identified by queries of the fan database, as disclosed above with additional reference to filters.

The groups are: (1) Millennial fans, of which there are 50,000 fans having a combined value of $200,000, or $4.00 per fan; (2) Luxury car owners, of which there are 2,000 fans having a combined value of $10,000, or $5.00 per fan; (3) Fans 65+ year old, of which there are 5,000 fans having combined a value of $30,000, or $6.00 per fan; (4) Season ticket holders, of which there 12,005 fans having a combined value of $120,050, or $10.00 per fan; (5) New app users in 2021, of which there are 7,520 fans having a combined value of $15,040, or $2.00 per fan; and (6) Fans who haven't bought tickets yet, of which there are 10,000 fans having a combined value of $25,000, or $2.50 per fan.

In one embodiment, the combined value of fans for any group is determined by the multiplying the per fan value by the number of fans in the group. In this embodiment, marketing experts on the client side determine the per fan value for each particular group. In another embodiment, a value for each fan in the group is determined algorithmically by the data exchange server. Each fan may have different values. The value of all fans in the group are added to determine the total value. The per fan value is then the average value of all fans, that is the total value divided by the number of fans identified in the query.

In one embodiment fan value is algorithmically determined by defining an attribute point value table that assigns point values to some or all possible attributes in table of the fan database. Each point value represents a dollar amount, or fraction of a dollar amount. These values are predetermined or preselected.

The attributes associated with a fan are checked against the attribute point table. The initial fan value is zero. If a fan has the attribute, the points associated with that attribute is added to the fan value (or subtracted, in the case that value is negative, or has no effect in the case that the attribute point value is zero). This repeats for all attributes of the fan, resulting in a unique monetary value for the fan. In this way, a monetary value for every fan profile in the fan database may be computed. The fan values may be stored in a fan value database associated with the fan database.

Turning back to FIG. 11A, “Millennial fans” are selected by the Lexus advertising executive as the audience. The “Next” button is selected. FIG. 11B shows the next screen which allows the Lexus to configure the campaign offer. The title of the offer is “Try the 2022 Lexus NX”. The promotional message is “Stop by a Lexus dealer. Check out the 2022NX. Get Paid.”

Lexus is offering a financial incentive to fans. The incentive is being offered to only if the fan's traits meet certain requirements. In this example, to be eligible for this offer, the fan must have certain traits. The fan's name must exist in the fan database. The fan's email address must be confirmed. And the location of the fan must be within 1 mile of 5 locations. The locations can be configured and are, for example, locations of Lexus dealers in the Dallas-Fort Worth area.

Lexus is offering $10.00 USD or 0.001 ETH ( 1/1000 of an Ethereum coin) to qualified fans who stop by a Lexus dealer to check out the 20222 NX. Lexus submits the campaign offer by clicking the “Next” button.

FIG. 11C shows the next screen summarizing the campaign. Upon clicking “Next”, a confirmation message is displayed. The confirmation of FIG. 11D informs the advertiser that the offer was sent to the client, in this case the Dallas Mavericks, for approval. Once approved the campaign, becomes active.

FIGS. 7A-E shows exemplary screens of a fan app, for example the Dallas Mavericks app, for a fan targeted by the activated campaign shown in FIGS. 6A-C. For each fan that is in the audience of Millennials and that have the traits and behaviors required by the campaign (e.g. name exists, email address confirmed, and presently within 1 mile of 5 locations), the fan receives an alert on their phone.

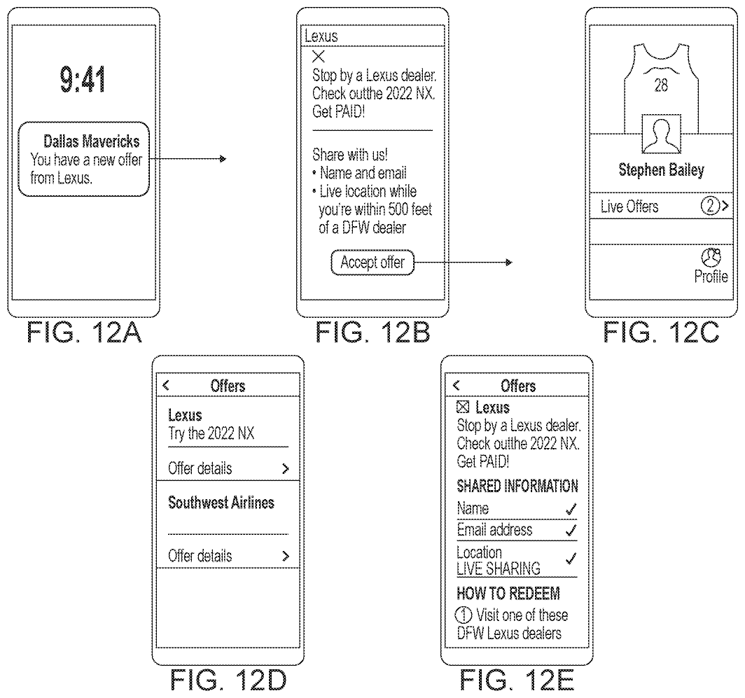

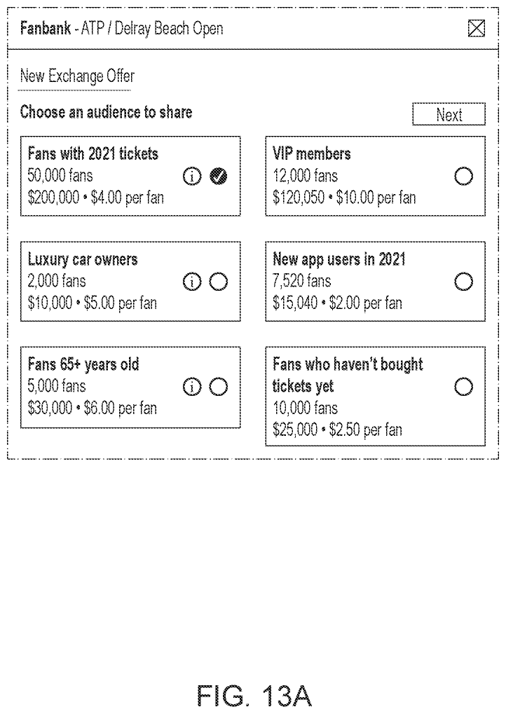

FIG. 12A shows the alert “You have a new offer from Lexus”. Upon clicking the offer, the offer is display. FIG. 12B shows the offer. The offer is, “Stop by a Lexus dealer. Check out the 2022NX. Get paid.” Also displayed is what the fan must be willing to share to receive the financial incentive. In this case, the fan must be willing to share name and email address. And the fan's live location must be withing 1 mile of a Dallas-Fort Worth Lexus dealership (one of five, as set in the campaign described above). The fan may then accept the offer and claim their $10.00 or 0.001 ETH when they stop by an approved Lexus dealer. In one embodiment, a confirmation code displayed on the Fan's app to be shown and confirmed by Lexus when the Fan goes to the dealership.

In this way the fan retains control of their data, deciding whether to share it or not with advertisers. In this way, the advertiser is able to incentivize the fan to share data that is of value to the advertiser. In this way, compliance with evolving data privacy concerns and regulations is maintained. Exemplary data privacy regulation include CCPA, CPRA, and GDPR.

FIG. 12C shows an exemplary screen of the app which displays the fans name and number of Live Offers he has. Live Offers can be selected. When selected, FIG. 12D shows the “Offers” screen displaying two live offers, one from Lexus and another from Southwest Airlines. “Offer Details” can be selected to view the details of the offer. In FIG. 12E the details of the Lexus offer are displayed. In this way, a fan can see the offers that he or she is participating in, their statuses, in addition to the data that they have shared.

The data exchange module 302 of FIG. 1 also enables the exchange of data between clients, such as between Client 1 308 and Client 2 309. In one example, the Association of Tennis Professionals (ATP) may be interested in fans that have 2021 tickets for the Delray Beach Open, and the Delray Beach Open may be interested in Tennis TV subscribers, assuming certain traits are present. ATP and Delray Beach Open have mutual or overlapping interests in that their fan base is similar. However, one organization does not have access to the other organization's fan profiles.

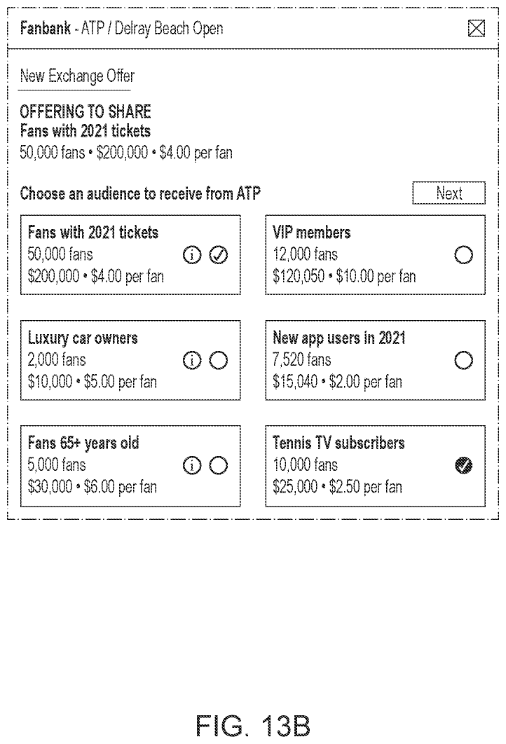

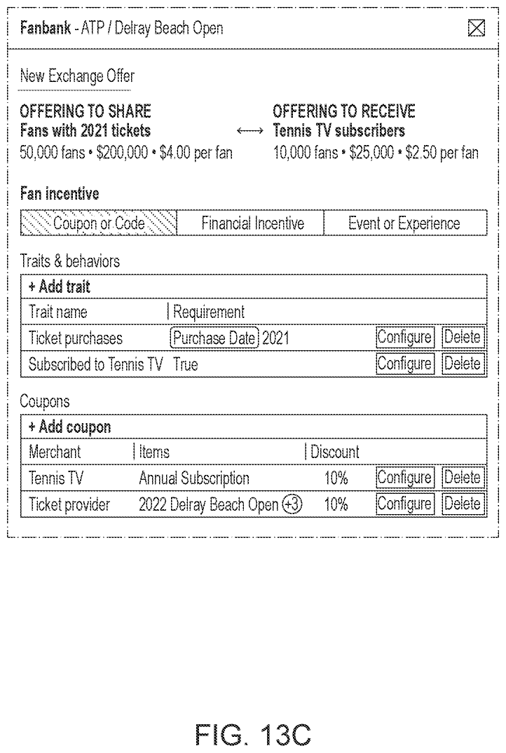

FIGS. 13A-C shows configuration screens of an exemplary offer to exchange data between clients. In FIG. 13A, several audiences are available to share. In this example, Fans with 2021 tickets are selected to be offered for exchange with ATP. There are 50,000 fans with a total value of $200,000, or $4.00 per fan. Audiences and fan values were discussed above with reference to. FIGS. 11A-D.

In FIG. 13B, the desired audience to receive from ATP is Tennis TV subscribers. There are 10,000 Tennis TV subscribers having a total value of $25,0000, or $2.50 per fan.

In FIG. 13C, the new exchange offer is displayed, namely an offer to share Fans with 2021 tickets for Tennis TV subscribers. Certain traits and behaviors must exist for the trade of any particular fan data. As can be seen, ticket purchases of a fan must have a purchase date of in 2021 and the fan must be subscribed to Tennis TV. If a fan has both of these traits and are willing to share their fan data, they may receive coupons. For example, a Delray Beach Open qualifying fan would receive a 10% off coupon for an annual subscription to Tennis TV. And a qualifying Tennis TV subscriber would receive a 10% off coupon to the 2022 Delray Beach Open.

Alerts and acceptance of the offer may be sent to qualifying fan via the ATP app and Tennis TV app in a similar manner as described with reference to FIGS. 12A-12D. Upon acceptance of the offer, digital coupons may be stored by the app, which may be applied to a subscription or ticket purchase. Those purchased may be made via the app.

In this way, organizations can trade data, while the fan remains in control of the data associated with their profile. Furthermore the fan is incentivized to share some of their data.

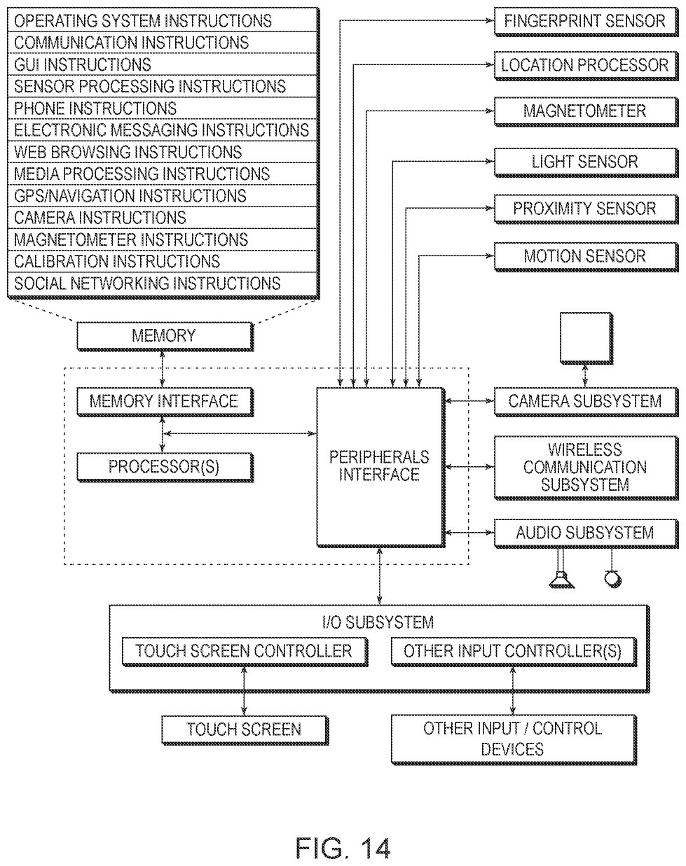

With reference above to apps running on mobile phones, FIG. 14 shows the architecture of an exemplary mobile communication device.

The methods and systems disclosed herein may be implemented on any computer communicating over any network. For example, the computers may include desktop computers, tablets, handheld devices, laptops and mobile devices. The mobile devices may comprise many different types of mobile devices such as cell phones, smart phones, portable computers, tablets, and any other type of mobile device operable to transmit and receive electronic messages.

One example of a mobile communication device is a smartphone such as an iPhone or Android phone. Another example of a mobile computing device is a tablet such as a computer tablet such as an iPad, Samsung Galaxy, Microsoft Surface. Other types of mobile communication devices include smart watches and smart glasses. Those skilled in the art will appreciate that there are many types of mobile communication devices compatible with the present invention. FIG. 14 shows the architecture of an exemplary mobile communication device.

While components of certain systems such as system 30 of FIG. 1 are shown together, some of all of the modules of system 30 may be implemented on a cloud computing platform such as on Amazon Cloud Services or Microsoft Azure, and may include one or more computer servers. In that case, the connections and communications between the various modules are made via a network such as network 10.

The computer network(s) may include the internet and wireless networks such as a mobile phone network. Network work is the internet but may comprise several other interoperable networks. Any reference to a “computer” is understood to include one or more computers operable to communicate with each other. Computers and devices comprise any type of computer capable of storing computer executable code and executing the computer executable code on a microprocessor, and communicating with the communication network(s). For example, a computer may be a web server.

The systems and methods may be implemented on an Intel or Intel compatible based computer running a version of the Linux operating system or running a version of Microsoft Windows, Apple OS, Android, iOS, and other operating systems. Computing devices based on non-Intel processors, such as ARM devices may be used. Various functions of any server, mobile device or, generally, computer may be implemented in hardware and/or in software, including in one or more signal processing and/or application specific integrated circuits.

The computers and, equivalently, mobile devices may include any and all components of a computer such as storage like memory and magnetic storage, interfaces like network interfaces, and microprocessors. For example, a computer comprises some of all of the following: a processor in communication with a memory interface (which may be included as part of the processor package) and in communication with a peripheral interface (which may also be included as part of the processor package); the memory interface is in communication via one or more buses with a memory (which may be included, in whole or in part, as part of the processor package; the peripheral interface is in communication via one or more buses with an input/output (I/O) subsystem; the I/O subsystem may include, for example, a graphic processor or subsystem in communication with a display such as an LCD display, a touch screen controller in communication with a touch sensitive flat screen display (for example, having one or more display components such as LEDs and LCDs including sub-types of LCDS such as IPS, AMOLED, S-IPS, FFS, and any other type of LCD; the I/O subsystem may include other controllers for other I/O devices such as a keyboard; the peripheral interface may be in communication with either directly or by way of the I/O subsystem with a storage controller in communication with a storage device such a hard drive, non-volatile memory, magnetic storage, optical storage, magneto-optical storage, and any other storage device capable of storing data; the peripheral interface may also be in communication via one or more buses with one or more of a location processor such as a GPS and/or radio triangulation system, a magnetometer, a motion sensor, a light sensor, a proximity sensor, a camera system, fingerprint sensor, wireless communication subsystem(s), and audio subsystems.

A non-transitory computer readable medium, such as the memory and/or the storage device(s) includes/stores computer executable code which when executed by the processor of the computer causes the computer to perform a series of steps, processes, or functions. The computer executable code may include, but is not limited to, operating system instructions, communication instruction, GUI (graphical user interface) instructions, sensor processing instructions, phone instructions, electronic messaging instructions, web browsing instructions, media processing instructions, GPS or navigation instructions, camera instructions, magnetometer instructions, calibration instructions, an social networking instructions.

An application programming interface (API) permits the systems and methods to operate with other software platforms such as Salesforce CRM, Google Apps, Facebook, Twitter, Instagram, social networking sites, desktop and server software, web applications, mobile applications, and the like. For example, an interactive messaging system could interface with CRM software and GOOGLE calendar.

A computer program product may include a non-transitory computer readable medium comprising computer readable code which when executed on the computer causes the computer to perform the methods described herein. Databases may comprise any conventional database such as an Oracle database or an SQL database. Multiple databases may be physically separate, logically separate, or combinations thereof.

The features described can be implemented in any digital electronic circuitry, with a combination of digital and analog electronic circuitry, in computer hardware, firmware, software, or in combinations thereof. The features can be implemented in a computer program product tangibly embodied in an information carrier (such as a hard drive, solid state drive, flash memory, RAM, ROM, and the like), e.g., in a machine-readable storage device or in a propagated signal, for execution by a programmable processor; and method steps can be performed by a programmable processor executing a program of instructions to perform functions and methods of the described implementations by operating on input data and generating output(s).

The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any type of programming language (e.g., Objective-C, Python, Swift, C#, JavaScript, Rust, Scala, Ruby, GoLang, Kotlin, HTML5, etc.), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. Some elements of a computer are a processor for executing instructions and one or more memories for storing instructions and data. Generally, a computer will also include, or communicate with one or more mass storage devices for storing data files. Exemplary devices include magnetic disks such as internal hard disks and removable disks, magneto-optical disks, and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) for displaying information to the user and a keyboard and a pointing device such as a mouse, trackball, touch pad, or touch screen by which the user can provide input to the computer. The display may be touch sensitive so the user can provide input by touching the screen.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, wired and wireless packetized networks, and the computers and networks forming the Internet.

The foregoing detailed description has discussed only a few of the many forms that this invention can take. It is intended that the foregoing detailed description be understood as an illustration of selected forms that the invention can take and not as a definition of the invention. It is only the claims, including all equivalents, that are intended to define the scope of this invention.

What is claimed is:

1. A valuation method for determining a monetary value of a sports fan comprising the steps of:
(a) providing a plurality of fan traits;
(b) ingesting first party data, second party data, and third party data from a plurality of data sources operable to provide demographic, transactional, and membership data of sports fans;
(c) processing the ingested data to extract fan traits values for a plurality of fans;
(d) storing the fan trait values with the fan traits for each of the plurality of fans in a fan database;
(e) defining a trait value category having a minimum category monetary value and a maximum category monetary value;
(f) defining a plurality of trait value properties associated with the trait value category, wherein the trait value properties comprise rules that map fan trait values in the fan database to points;
(g) for a fan, computing a point value for the plurality of trait value properties according to the rules;
(h) for the fan, computing a monetary value of the trait value category by converting the point value to a monetary value in the range of the minimum category monetary value and maximum category monetary value define is step (e);
(i) repeating the steps of (e)-(h) to determine additional trait value category monetary values for the fan;
determining the fan profile value by adding all of the trait value category monetary values in (i); and
(k) generating web browser executable code accessible over the internet that when accessed by a remote computer of a sports client or advertiser causes the display of the remote computer to display a fan profile page including the fan profile value, demographic data, and fan activity information.

2. The method of claim 1 further comprising the step of repeating the steps of (g)-(j) for each fan of the plurality of fans in the fan database.

3. The method of claim 2 further comprising the step of determining the total value of the fan database; and generating web browser executable code accessible over the internet that when accessed by a remote computer of a sports client or advertiser, causes the display of the remote computer to display the total fan value.

4. The method of claim 3 further comprising the steps of filtering the fan data, determining the value of filtered fan data, and generating web browser executable code accessible over the internet that when accessed by a remote computer of a sports client or advertiser, causes the display of the remote computer to display the value of the filtered fan data.

5. The method of claim 1 further comprising filtering for fans having particular traits and creating a financial incentive campaign for a company that would like to advertise to sports fans having the particular traits.

6. A system for determining a monetary value of a sports fan comprising:
(a) means for providing a plurality of fan traits;
(b) means for ingesting first party data, second party data, and third party data from a plurality of data sources operable to provide demographic, transactional, and membership data of sports fans;
(c) means for processing the ingested data to extract fan traits values for a plurality of fans;
(d) means for storing the fan trait values with the fan traits for each of the plurality of fans in a fan database;
(e) means for defining a trait value category having a minimum category monetary value and a maximum category monetary value;
(f) means for defining a plurality of trait value properties associated with the trait value category, wherein the trait value properties comprise rules that map fan trait values in the fan database to points;
(g) for a fan, means for computing a point value for the plurality of trait value properties according to the rules;
(h) for the fan, means computing a monetary value of the trait value category by converting the point value to a monetary value in the range of the minimum category monetary value and maximum category monetary value;
(i) means for determining additional trait value category monetary values for the fan;
(j) means determining the total fan profile value; and
(k) means for generating web browser executable code accessible over the internet that when accessed by a remote computer of a sports client or advertiser causes the display of the remote computer to display a fan profile page including the fan profile value, demographic data, and fan activity information.

7. A non-transitory computer-readable medium comprising instructions which, when executed by a processor, causes the processor to the perform the steps of:
(a) providing a plurality of fan traits;
(b) ingesting first party data, second party data, and third party data from a plurality of data sources operable to provide demographic, transactional, and membership data of sports fans;
(c) processing the ingested data to extract fan traits values for a plurality of fans;
(d) storing the fan trait values with the fan traits for each of the plurality of fans in a fan database;
(e) defining a trait value category having a minimum category monetary value and a maximum category monetary value;
(f) defining a plurality of trait value properties associated with the trait value category, wherein the trait value properties comprise rules that map fan trait values in the fan database to points;
(g) for a fan, computing a point value for the plurality of trait value properties according to the rules;
(h) for the fan, computing a monetary value of the trait value category by converting the point value to a monetary value in the range of the minimum category monetary value and maximum category monetary value define is step (e);
(i) repeating the steps of (e)-(h) to determine additional trait value category monetary values for the fan;
(j) determining the fan profile value by adding all of the trait value category monetary values in (i); and
(k) generating web browser executable code accessible over the internet that when accessed by a remote computer of a sports client or advertiser causes the display of the remote computer to display a fan profile page including the fan profile value, demographic data, and fan activity information.

8. The computer-readable medium of claim 7 further comprising instructions which, when executed by a processor, causes the processor to perform the step of (g)-(j) for each fan of the plurality of fans in the fan database.

9. The computer-readable medium of claim 7 further comprising instructions which, when executed by a processor, causes the processor to perform the step of determining the total value of the fan database; and generating web browser executable code accessible over the internet that when accessed by a remote computer of a sports client or advertiser, causes the display of the remote computer to display the total fan value.

10. The computer-readable medium of claim 7 further comprising instructions which, when executed by a processor, causes the processor to perform the step of filtering the fan data, determining the value of filtered fan data, and generating web browser executable code accessible over the internet that when accessed by a remote computer of a sports client or advertiser, causes the display of the remote computer to display the value of the filtered fan data.
